(19) United States
(12) Patent Application Publication
(10) Pub. No.: US 2017/0177824 A1
(43) Pub. Date: Jun. 22, 2017

(54) HEALTHCARE MANAGEMENT SYSTEM AND METHOD FOR EVALUATING PATIENTS

(71) Applicant: Medical Home Network, Chicago, IL (US)

(72) Inventors: Laura Merrick, Chicago, IL (US); Arthur Jones, Chicago, IL (US); Tina Spector, Chicago, IL (US); Cheryl Lulias, Chicago, IL (US)

(21) Appl. No.: 14/975,194

(22) Filed: Dec. 18, 2015

(51) Int. Cl. G06F 19/00; G08B 21/02

(52) U.S. Cl. CPC G06F 19/3431; G06F 19/3487; G06F 19/3443; G06F 19/322; G08B 21/02

(57) ABSTRACT

A healthcare management system generally comprises a client member that is configured to receive data associated with a patient, wherein the data includes a plurality of health condition variables. A health management service provider is configured to couple to the client member via a network, wherein the health management service provider is further configured to receive the data transmitted from the client member and to determine a plurality of weighted values that are associated with the health condition variables. The health management service provider is also configured to compute a risk score associated with the patient based on the weighted values associated with the health condition variables and output a message to an external device based on the risk score.

### BACKGROUND

Healthcare is a patchwork of different healthcare providers from hospitals to medical homes to health insurance providers that provide different services to patients. The patchwork includes coordination between the healthcare providers attending to the needs of their patients. With the implementation of the Affordable Care Act (“ACA”) in the United States, healthcare providers are being judged and compensated based on outcome, therefore quality rather than quantity. Consequently, healthcare providers are being incentivized to provide higher quality healthcare at a lower cost.

### SUMMARY

Embodiments described herein enable efficient communication between client members (i.e., healthcare clinics, medical homes, or hospitals) and health management service providers, wherein patient data and the results of various different patient analyses can be transmitted and communicated between client members and health management service providers in real time or in close to real time, e.g., a few minutes or hours as opposed to days or months to facilitate managing the healthcare needs of patients. For example, in some embodiments, a healthcare management system is provided that includes a client member that is configured to receive data associated with a patient, wherein the data includes a plurality of health condition variables. A health management service provider is configured to couple to the client member via a network, wherein the health management service provider is further configured to receive the data transmitted from the client member and to determine a plurality of weighted values that are associated with the health condition variables. The health management service provider is also configured to compute a risk score associated with the patient based on the weighted values associated with the health condition variables and output a message to an external device based on the risk score.

In other embodiments, a method for evaluating a patient using a computing device is provided. Data associated with the patient is obtained via the computing device, wherein the data includes a plurality of health condition variables. A plurality of weighted values that are associated with the plurality of health condition variables are determined. A risk score associated with the patient is computed based on the plurality of weighted values associated with the health condition variables. A message is transmitted to an external device based on the risk score.

In yet other embodiments, a method for evaluating a patient using a computing a device is provided, wherein the method includes obtaining data associated with the patient via the computing device, and wherein the data includes a plurality of identification variables and a plurality of health condition variables. A database that includes a plurality portfolios that each corresponds to a different existing patient member is accessed. The identification variables for the patient are compared with the portfolios in the database to identify whether a match exists for the patient. A risk score for the patient is computed when the match is identified, wherein the risk score is based on a plurality of weighted values associated with the health condition variables. A message is transmitted to an external device based on the risk score.

### BRIEF DESCRIPTION OF THE DRAWINGS

The present invention is illustrated by way of example, and not by way of limitation, in the figures of the accompanying drawings and in which like reference numerals refer to similar elements.

FIGS. 1A-1C are block diagrams of an exemplary healthcare management system that includes at least one client member and a health management service provider; and

FIGS. 2A-2C are diagrams of exemplary methods for evaluating at least one patient using the healthcare management system shown in FIGS. 1A-1C.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications, and equivalents, which may be included within the scope of the invention as construed according to the appended Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “identifying,” “creating,” “generating,” “storing,” “determining,” “sending,” “receiving,” “transmitting,” “communicating,” “providing,” “accessing,” “associating,” “disabling,” “enabling,” “configuring,” “initiating,” “starting,” “terminating,” “ending,” “maintaining,” “detecting,” “initializing,” “updating” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

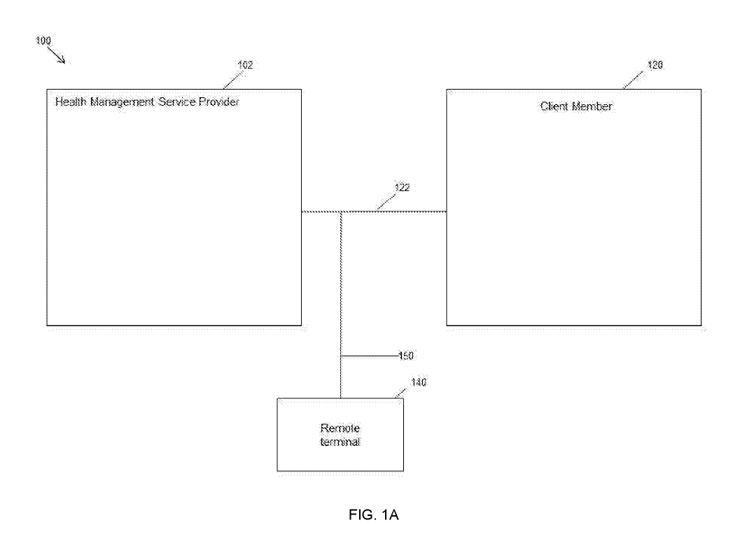

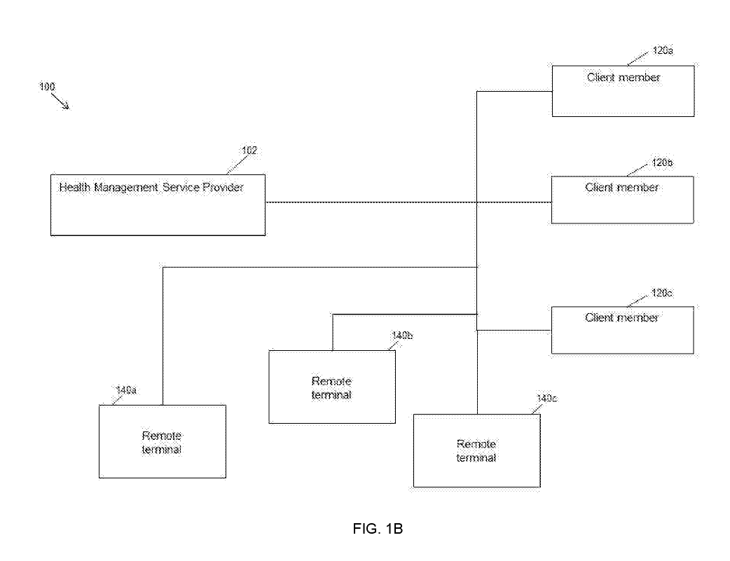

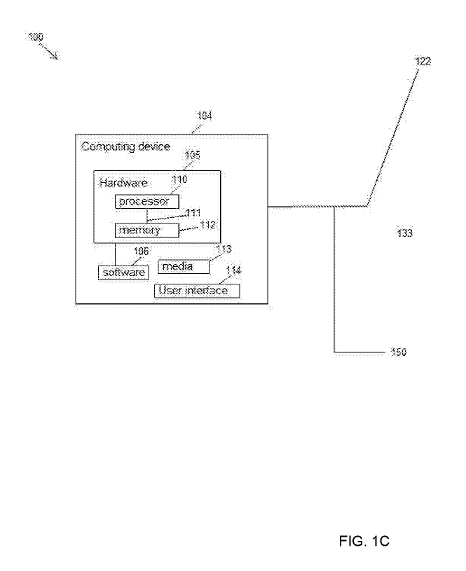

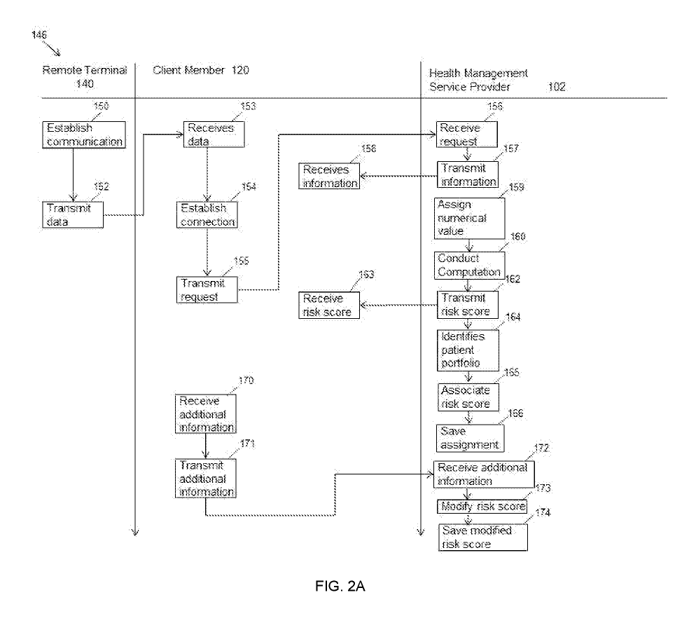

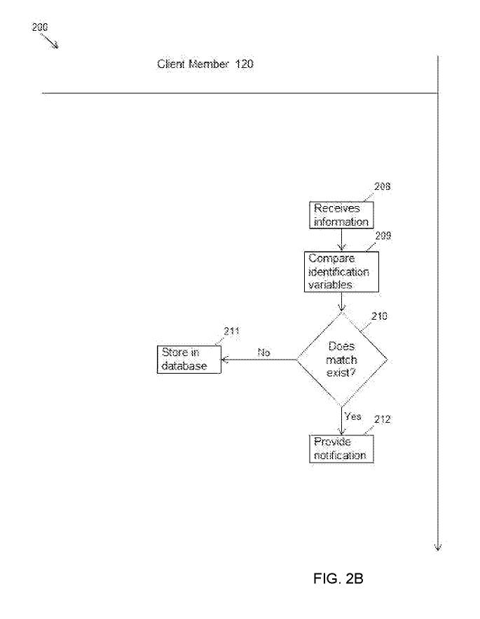

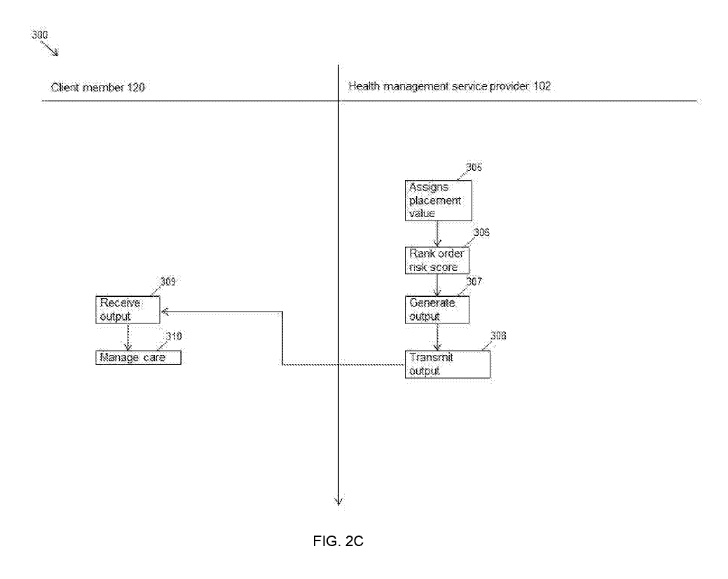

The embodiments described herein facilitate efficient communication between client members (i.e., healthcare clinics, medical homes, or hospitals) and health management service providers. Patient data and the results of various different patient analyses can be transmitted and communicated between client members and health management service providers in real time or in close to real time, e.g., a few minutes or hours as opposed to days or months such that patients can be adequately and appropriately treated. For example, in some embodiments, as explained in more detail below with respect to FIGS. 1 and 2, data can be obtained for one or more patients by one or more client members and the data can be communicated to the health management service provider. Based on the data, a risk score can be determined for the patient in real-time by either the client member or the health management service provider or any combination thereof. The determined risk score can then be used to facilitate managing the healthcare needs of the patient and to provide appropriate medical attention to the patient. For example, in some embodiments, a higher risk score can be used to alert the client member that the patient requires heightened medical attention during routine visits, hospitalizations, and/or emergency care.

FIGS. 1A-1C each illustrates an exemplary healthcare management system 100 that facilitates the management of patient care. Referring to FIG. 1A, healthcare management system 100 includes a health management service provider 102, at least one client member 120 (only one being shown in FIG. 1A), and at least one remote terminal 140 (only one being shown in FIG. 1A) being used by a patient or by the client member 120 or any combination thereof. In some embodiments, client member 120 can be, for example, a hospital, clinic, acute care clinic, medical home, or center for Medicare and Medicaid services. Health management service provider 102, in some embodiments, is configured to provide a platform for client member 120 to share and exchange patient information with, for example, other client members. In some embodiments, remote terminal 140 can be a desktop computer, laptop, mobile device, tablet, thin client, or other device having a communications interface (not shown) such that a user, such as a patient the client member 120 or any combination thereof, can use remote terminal 140 to communicate with client member 120 and/or health management service provider 102.

As explained in more detail below with respect to FIG. 2A, client member 120, health management service provider 102, and remote terminal 140 can efficiently communicate patient information and provide evaluation information to each other about the patient in real time such that the patient can be adequately treated by client member 120. For example, using remote terminal 140, the patient can transmit patient information or data to client member 120. The data can include various information about the patient. For example, in some embodiments, the data can include admission data and treatment data. The admission data can include various identification variables including, but not limited to, health insurance information, such as an insurance identification number and a benefit identification number, a date of birth for the patient, a residential address for the patient, an email address for the patient, a phone number for the patient, etc. The treatment data can include various health condition variables including, but not limited to, pre-existing conditions, current physical conditions the patient is experiencing, a diagnosis type, prescription medication, lab results, etc.

In some embodiments, rather than using remote terminal 140, client member 120 can obtain the data from the patient directly as well as the historical data associated with the patient, e.g., via the electronic medical record, lab works, etc. For example, the patient can come into a facility, such as an emergency care facility, of client member 120 and the patient can provide his or her information to a staff member at the facility. Based on the information or data provided by the patient, client member 120 and/or health management service provider 102 can determine a risk score for the patient. The determined risk score can be used by client member 120 and other client members to facilitate managing the healthcare needs of the patient and to provide appropriate medical attention to the patient. For example, in some embodiments, a higher risk score can be used to alert client member 120 or other client members that the patient requires heightened medical attention during routine visits, hospitalizations, or emergency care.

In other embodiments, as explained in more detail below with respect to FIG. 2B, by using the information provided by the patient, client member 120 or health management service provider 102 can determine whether the patient is a patient of interest. For example, in some embodiments, client member 120 can communicate with health management service provider 102 and access a database (not shown) stored within, for example, health management service provider 102, wherein the database can include a plurality of portfolios that each corresponds to a different existing patient member. After accessing the information from the database, client member 120 can determine whether the patient is a patient of interest. In some embodiments, a patient of interest can be a patient that matches with an existing patient portfolio already contained within the database. If a match is determined for the patient, then client member 120 and/or health management service provider 102 determines a risk score for the patient. The determined risk score can be used by client member 120 and other client members to facilitate managing the healthcare needs of the patient and to provide appropriate medical attention to the patient.

Referring to FIG. 1B, health management service provider 102, in some embodiments, can be in communication with more than one client member 120, such as client member 120a, client member 120b, and client member 120c, and several remote terminals 140, such as remote terminal 140a, remote terminal 140b, and remote terminal 140c, wherein each remote terminal is being used by a different patient. As explained in more detail below with respect to FIG. 2C, client members 120a, 120b, and 120c, health management service provider 102, and remote terminals 140a, 140b, and 140c can efficiently communicate patient information and provide evaluation information to each other about each patient in real time such that the patients can be adequately treated by each of client member 120. For example, using their respective remote terminals 140a, 140b, and 140c, each patient can transmit patient information or data to one or more of the client members 120. In some embodiments, rather than using their respective remote terminal 140, each client member 120 can obtain the data from each patient directly. For example, each patient can come into a facility, such as an emergency care facility, of one of the client members 120 and each patient can provide his or her information to a staff member at the facility. Based on the information or data provided by the patient, each client member 120 and/or health management service provider 102 can determine a risk score for each of the patient. The determined risk score can be used by each of the client members 120 to facilitate managing the healthcare needs of the patients and to provide appropriate medical attention to the patients. For example, in some embodiments, the patient with the highest risk score can be used to alert each client member 120 that the patient requires heightened medical attention during routine visits, hospitalizations, or emergency care, and would need to be treated prior to the other patients.

Referring to FIG. 1C, in order to facilitate the operation of healthcare management system 100, system 100 includes one or more computing devices, servers, or hosts 104, which can be used by health management service provider 102 (shown in FIGS. 1A and 1B). In the some embodiments, computing device 104 includes a hardware unit 105 and software 106. Software 106 can run on hardware unit 105 such that various applications or programs can be executed on hardware unit 105 by way of software 106. In some embodiments, the functions of software 106 can be implemented directly in hardware unit 105, e.g., as a system-on-a-chip, firmware, field-programmable gate array (“FPGA”), etc. In some embodiments, hardware unit 105 includes one or more processors, such as processor 110. In some embodiments, processors 110 is an execution unit, or “core,” on a microprocessor chip. In some embodiments, processors 110 may include a processing unit, such as, without limitation, an integrated circuit (“IC”), an application specific integrated circuit (“ASIC”), a microcomputer, a programmable logic controller (“PLC”), and/or any other programmable circuit. Alternatively, processor 110 may include multiple processing units (e.g., in a multi-core configuration). The above examples are exemplary only, and, thus, are not intended to limit in any way the definition and/or meaning of the term “processor.”

Hardware unit 105 also includes a system memory 112 that is coupled to processor 110 via a system bus 111. Memory 112 can be a general volatile random access memory (“RAM”). For example, hardware unit 105 can include a 32 bit microcomputer with 2 Mbit ROM and 64 Kbit RAM. Memory 112 can also be a read-only memory (“ROM”), a network interface (“NIC”), and/or other device(s). In some embodiments, computing device 104 can also include at least one media output component 113 for use in presenting information to a user. Media output component 113 can be any component capable of conveying information to a user and may include, without limitation, a display device (not shown) (e.g., a liquid crystal display (LCD), an organic light emitting diode (OLED) display, or an audio output device (e.g., a speaker or headphones)).

In some embodiments, computing device 104 includes an input or a user interface 114 for receiving input from a user. User interface 114 may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of media output component 113 and user interface 114.

In some embodiments, computing device 104 can be connected to one or more client members 120 (shown in FIGS. 1A and 1B) via, for example, a network 122. Network 122 can be the Internet, a local area network (“LAN”), a wide area network (“WAN”), a personal area network (“PAN”), or any combination thereof, and network 122 can transmit information between service provider 102 and client member 120. Client member 120 can be, for example, a hospital, clinic, acute care clinic, medical home, or center for Medicare and Medicaid services. Health management service provider 102, in some embodiments, is configured to provide a platform for client member 120 to share and exchange patient information with the other client members. Client member 120 may include similar components as the health management service provider 102 described herein and it may operate in a similar fashion.

In some embodiments, one or more users, such as patients (not shown), may physically visit client member 120 such that patient information can be provided to client member 120. Alternatively, in some embodiments, the users may connect to, and interact with client member 120 and/or health management service provider 102 by using separate remote terminals. For example, in some embodiments, one or more patients can connect to client member 120 and/or health management service provider 102 by using one or more remote terminals 140 (shown in FIGS. 1A and 1B).

FIG. 2A is a diagram 146 of an exemplary method for evaluating at least one patient using healthcare management system 100 (shown in FIGS. 1A-1C). In step 150, at least one patient can use remote terminal 140 to establish a connection with client member 120. For example, in some embodiments, remote terminal 140 connects with client member 120 via, for example network 150 (shown in FIG. 1C). As such, the patient can communicate with client member 120. In step 152, using remote terminal 140, the patient can transmit data to client member 120. It is appreciated that a patient using the remote terminal 140 to transmit data to the client member 120 is optional in some embodiments. As described above, the data can include various information about the patient. For example, in some embodiments, the data can include admission data and treatment data. The admission data can include various identification variables including, but not limited to, health insurance information, such as an insurance identification number and a benefit identification number, a date of birth for the patient, a residential address for the patient, an email address for the patient, a phone number for the patient, etc. The treatment data can include various health condition variables including, but not limited to, pre-existing conditions, current physical conditions the patient is experiencing, a diagnosis type, prescription medication, lab results, etc.

In step 153, client member 120 receives the data. In some embodiments, rather than using remote terminal 140, client member 120 can obtain the data from the patient directly when the patient comes into a facility of client member 120 and directly has the data be inputted to a computing device being used by client member 120. For example, the patient can go to a facility, such as an emergency room facility, of client member 120 and provide data, such as any symptoms he or she is experiencing, along with any general patient information, such as date of birth or address, to a staff member or healthcare provider for client member 120. In some embodiments, the staff member can input the data to a computing device, such as computing device 104 (shown in FIG. 1C), or have the patient directly input the data into the computing device. In some embodiments, the patient may use emote terminal 140 to transmit the data directly to health management service provider 102. For example, in some embodiments, remote terminal 140 can connect with health management service provider 102 and transmit the data to computing device 104 using network 150. In some embodiments, information can be received by health management service provider 102 and/or client member 120.

The data can include various information about the patient. For example, in some embodiments, the data can include admission data and treatment data. The admission data can include various identification variables including, but not limited to, health insurance information, such as an insurance identification number and a benefit identification number, a date of birth for the patient, a residential address for the patient, an email address for the patient, a phone number for the patient, etc. The treatment data can include various health condition variables including, but not limited to, pre-existing conditions, current physical conditions the patient is experiencing, a diagnosis type, prescription medication, lab results, etc.

In some embodiments, the data obtained can be based on answers that the patient provided via a questionnaire that is provided to the patient. For example, when the patient goes into the facility for client member 120, the patient can be provided with a hard copy of a questionnaire in which the patient provides information, such as the health insurance information, physical address, physical conditions, mental health related information, etc. This information can then be entered into a computing device, such as computing device 104, for example, via user interface 114 (shown in FIG. 1C). For example, the computing device may generate a display output (not shown) in which various fields are required to be answered. In some embodiments, the patient may directly input the information to the computing device. In some embodiments, the data can be entered to the computing device by a healthcare provider, such as a nurse or a physician, at the facility of member 120, wherein the healthcare provider can include information related to their examination or treatment of the patient, such as a diagnosis or physical condition of the patient.

In step 154, client member 120 establishes a connection with health management service provider 102. For example, client member 120 connects with health management service provider 102 via, for example network 122 (shown in FIG. 1C). As such, the client member 120 can communicate with health management service provider 102. In step 155, client member 120 transmits a request to health management service provider 102 for permission to access a database (not shown) stored therein. Health management service provider 102 receives the request in step 156. In step 157, health management service provider 102 transmits information from the database to client member 120, and, in step 158, client member 120 receives information from the database. The transmission and receipt of information from the database can occur in real time. In alternative embodiments, the database may be stored in a different location, such as a remote server (not shown) that is separate from health management service provider 102. As such, client member 120 can use steps 154-158 to access the database from the remote server as opposed to health management service provider. Moreover, steps 154-158 also enable client member 120 to submit information about the patient to health management service provider 102. It is appreciated that in some embodiments, the health management service provider 102 and the client member 120 may be integrated with one another. As such, separation of client member 120 from the health management service provider 102 is exemplary and not intended to limit the scope of the embodiments.

In some embodiments, the database can include healthcare data for existing patient members. For example, in some embodiments, the database can include healthcare data of patients that have been patients of client member 120 and other client members in the past. The database can include a plurality of portfolios that correspond to existing patient members. For example, each patient's portfolio can include admission data and treatment data obtained from past visits to client member 120 or to other client members. The database can be used by client member 120 for various purposes as explained in more detail with respect to FIG. 2B.

Health management service provider 102 can determine a risk score for the patient in real time. In some embodiments, the risk score can be a numerical value that is based on at least one of the health condition variables of the patient, such as a pre-existing condition (i.e., diabetes or COPD) or the type of diagnosis or the type of known diagnosis code used by healthcare providers (i.e., ICD. 10 codes E11.311—Type 2 Diabetes or J44.9—COPD). For example, upon receiving data about a patient from client member 120, health management service provider 102 assigns a numerical value to each health condition variable of the patient in step 159, wherein each numerical value is a weighted value associated with each variable. As such, each variable can be weighted differently as desired. For example, each hospitalization and/or emergency room visit of the patient within the past twelve months can be given a specific weighted score and each psycho-social condition, such as a substance abuse problem can be assigned with a different weighted score. In addition, each diagnosis and pre-existing condition of the patient can be assigned a different weighted score. Health management service provider 102 can then conduct a computation of each of the assigned numerical values in step 160, wherein the computation is the risk score. In some embodiments, the computation is a summation of the weighted scores. Alternatively, the risk score may be calculated by client member 120 using the same steps 159-160.

In some embodiments, after the risk score is determined, health management service provider 102 transmits the risk score to client member 120 in step 162. Client member 120 receives the risk score in step 163 in real time. The risk score can be used by client member 120 and other client members to facilitate managing the healthcare needs of the patient and to provide appropriate medical attention to the patient. In some embodiments, a higher risk score can be used to alert client member 120 or other client members that the patient requires heightened medical attention during routine visits, hospitalizations, or emergency care. In some embodiments, health management service provider 102 transmits the risk score to client member 120 via, for example, a text message to a mobile phone used by client member 120 or directly to remote terminal 140 being used by the patient. In some embodiments, the actual risk score may not be transmitted but, instead a different type of signal may be transmitted to client member 120 alerting of the need to provide care to the patient. For example, based on the risk score, healthcare management service provider 102 can transmit a signal to an alarm within a room of client member's facility where the patient is staying, wherein the signal causes the alarm to sound off such that healthcare providers are notified that the particular patient is requiring heightened medical care. In some embodiments, a signal can be transmitted to a display unit within a room of client member's facility where the patient is staying, wherein the display unit is a light emitting diode (“LED”), and the color of the LED can be lit up upon receiving the signal based on the risk score.

In some embodiments, health management service provider 102 can save the risk score to the database in real time so that other client members or client member 120 may be able to access the information from the database at a later time to facilitate appropriately addressing the healthcare needs of the patient in future visits. For example, in step 164, health management service provider 102 identifies one of the patient portfolios within the database that corresponds to the patient. In step 165, health management service provider 102 associates the determined risk score to the identified patient portfolio. In step 166, health management service provider 102 saves the assignment to the database.

In some embodiments, health management service provider 102 can modify the risk score. For example, client member 120 may receive additional information, such as a new health condition variable for the patient in step 170. The information can be provided by the patient on-site at a facility of client member 120. Alternatively, the patient may transmit the information from remote terminal 140 to client member 120. In step 171, client member 120 transmits the new health condition variable to health management service provider 102. Health management service provider 102 receives the additional information in step 172. In some embodiments, health service provider 102 may receive the information directly from the patient via remote terminal. In step 173, health management service provider 102 modifies or adjusts the previously determined risk score based, at least in part, on the new information, such as the new health condition variable. For example, health management service provider 102 can perform steps 159 and 160 again in which new or adjusted numerical values are assigned and a summation of the new or adjusted numerical values is computed.

In step 174, health management service provider 102 saves the modified risk score to the database. The modified risk score can then be used by client member 120 or other client members to appropriately manage the healthcare needs of the patient and to provide appropriate medical attention to the patient.

In some embodiments, prior to determining a risk score, the patient for which a risk score is needed can be identified. For example, FIG. 2B is a diagram 200 of an exemplary method for evaluating at least one patient using healthcare management system 100 (shown in FIGS. 1A-1C). After completing steps 150-158 (shown in FIG. 2A), client member 120 can determine whether the patient is a patient of interest. For example, in step 209, client member 120 compares the identification variables received from the patient with the portfolios in the database to identify whether there is match for the patient. In some embodiments, the match exists if the patient already has a portfolio in the database. In some embodiments, a match can be dictated by considering a specific medical record number, or a match based on demographics, such as name, date of birth, gender, and known addresses. In step 210, client member 120 determines whether there is a match. If there is no match, client member 120 can store the information about the patient in the database as part of a new portfolio in step 211. In some embodiments, depending on the nature of the physical condition(s) of the patient, client member 120 may not store the information as a new portfolio in the database and may just store the patient's information within any computing device being used by client member 120.

On the other hand, if a match is determined for the patient in step 210, then, in step 212, client member 120 notifies health management service provider 102 to generate a risk score using, for example, steps 159 and 160 (shown in FIG. 2A).

In some embodiments, risk scores can be calculated for multiple patients and the risk scores for each patient can be organized in real time such that the patient with the highest risk score can be prioritized for receiving care first. For example, FIG. 2C is a diagram 300 of an exemplary method for evaluating at least one patient using healthcare management system 100 (shown in FIGS. 1A-1C). After client member 120 receives information from more than one patient using steps as described above, such as steps 150-153 (shown in FIG. 2A), and after client member 120 establishes communication with health management service provider 102 as described above, such as steps 154-158 (shown in FIG. 2A), health management service provider 102 can obtain the information about each patient and determine a risk score for each patient using, for example, steps 159-160.

After the risk score is determined, health management service provider 102 assigns a placement rank value to each risk score received in step 305. For example, the risk score with the highest numerical value can be given a placement rank value of one or first place, while the risk score with the lowest numerical value can be given a placement rank value of last place or the last number based on the number of risk scores received. In step 306, health management service provider 102 rank orders the risk scores based on the placement value assignments. For example, the risk score with the placement rank value of one or first place can be ranked in first position, while the risk score with the placement rank value of last place can be ranked in last position.

In step 307, health management service provider 102 generates an output with the rank orders. In some embodiments, the output can include a list of the risk scores, wherein the risk score with the placement rank value of one or first place can be listed first. In some embodiments, an identification variable for the patient, such as the patient's name, can be included on the list next to the corresponding risk score. In step 308, health management service provider transmits the output to client member 120 and, in step 309, client member 120 receives the output. In some embodiments, the output can be a text message that is transmitted to, for example, a mobile phone used by client member 120 or to remote terminal 140 being used by a patient. In some embodiments, the output can be a signal that is transmitted to an alarm within a room of client member's facility where the highest risk patient is staying, wherein the signal causes the alarm to sound off such that healthcare providers are notified that the particular patient requires immediate attention. In some embodiments, the output can be a signal that is transmitted to a display unit within a room of client member's facility where the highest risk patient is staying, wherein the display unit is a light emitting diode (“LED”), and the color of the LED can be lit up upon receiving the signal based on the risk score. While in some embodiments the risk score is numerical, in other embodiments, the risk score can be stratified (i.e., high, medium, or low). In such both embodiments, the patients can be ranked with scores as well as other data points, such as the last contact time with a healthcare provider.

In step 310, client member 120 manages the healthcare needs of the patients based on the output provided by health management service provider. For example, when considering the rank order list, client member 120 can identify the patient with the highest risk score and client member 120 can treat or inspect this patient first. In addition, client member 120 can identify the patient with the lowest risk score and client member 120 can treat or inspect this patient after the other patients on the list have been treated.

Exemplary embodiments of systems and methods are described above in detail. The systems and methods are not limited to the specific embodiments described herein, but rather, components of each system and/or method may be utilized independently and separately from other components described herein. For example, each system may also be used in combination with other systems and is not limited to practice with only systems as described herein. Rather, the exemplary embodiment can be implemented and utilized in connection with many other applications.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

This written description uses examples to disclose the disclosure, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A healthcare management system comprising:
a client member configured to receive data associated with a patient, wherein the data includes a plurality of health condition variables; and
a health management service provider configured to couple to the client member via a network, wherein the health management service provider is further configured to:
receive the data transmitted from the client member;
determine a plurality of weighted values that are associated with the plurality of health and social condition variables;
compute a risk score associated with the patient based on the plurality of weighted values associated with the plurality of health condition variables; and
output a message to an external device based on the risk score.

2. The healthcare management system of claim 1, wherein the message is a text message.

3. The healthcare management system of claim 1, wherein the health management service provider is further configured to cause an alarm sound off

4. The healthcare management system of claim 1, wherein the health management service provider is further configured can a light emitting diode (“LED”) light associated with a room of the patient to be lit, wherein a color of the LED is lit based on the risk score.

5. The healthcare management system of claim 1, wherein the health management service provider is further configured to cause an automated phone call to be placed to the patient.

6. The healthcare management system of claim 1, wherein the data includes a plurality of identification variables associated with the patient.

7. The healthcare management system of claim 6, wherein the client member is further configured to:
access a database that includes a plurality portfolios that each corresponds to a different existing patient member; and
compare the plurality of identification variables for the at least one patient with the plurality of portfolios in the database to identify whether a match exists for the patient.

8. A method for evaluating a patient using a computing device, wherein the method comprises:
obtaining data associated with the patient via the computing device, wherein the data includes a plurality of health condition variables; and
determining a plurality of weighted values that are associated with the plurality of health condition variables;
computing a risk score associated with the patient based on the plurality of weighted values associated with the plurality of health condition variables; and
transmitting a message to an external device based on the risk score.

9. The method of claim 8, wherein transmitting a message to an external device comprises transmitting a text message to the external device.

10. The method of claim 8, further comprising causing an alarm to sound off.

11. The method of claim 8, further comprising causing a light emitting diode (“LED”) light associated with a room of the patient to be lit, wherein a color of the LED is lit based on the risk score.

12. The method of claim 8, further causing an automated phone call to be placed to the patient.

13. The method of claim 8, wherein the data includes a plurality of identification variables associated with the patient.

14. The method of claim 13, further comprising:
accessing a database that includes a plurality portfolios that each corresponds to a different existing patient member; and
comparing the plurality of identification variables for the patient with the plurality of portfolios in the database to identify whether a match exists for the patient.

15. A method for evaluating a patient using a computing device, wherein the method comprises:
obtaining data associated with the patient via the computing device, wherein the data includes a plurality of identification variables and a plurality of health condition variables;
accessing a database that includes a plurality portfolios that each corresponds to a different existing patient member;
comparing the plurality of identification variables for the patient with the plurality of portfolios in the database to identify whether a match exists for the patient;
computing a risk score for the patient when the match is identified, wherein the risk score is based on a plurality of weighted values associated with the plurality of health condition variables; and
transmitting a message to an external device based on the risk score.

16. The method of claim 15, wherein transmitting a message to an external device comprises transmitting a text message to the external device.

17. The method of claim 15, further comprising causing an alarm to sound off.

18. The method of claim 15, further comprising causing a light emitting diode (“LED”) light associated with a room of the patient to be lit, wherein a color of the LED is lit based on the risk score.

19. The method of claim 15, further causing an automated phone call to be placed to the patient.

20. The method of claim 15, further comprising saving the risk score to the database.
